(19) United States
(12) Patent Application Publication
(10) Pub. No.: US 2026/0253479 A1
(43) Pub. Date: Aug. 27, 2026

(54) FIRE EVENT DETECTION

(71) Applicant: Alarm.com Incorporated, Tysons, VA (US)

(72) Inventors: Wen-Ting Zhu, Fairfax, VA (US); Krishna Chaitanya Tummalapalli, Falls Church, VA (US)

(21) Appl. No.: 19/535,047

(22) Filed: Feb. 10, 2026

Related U.S. Application Data
(60) Provisional application No. 63/764,196, filed on Feb. 27, 2025.

(51) Int. Cl. G08B 17/12

(52) U.S. Cl. CPC G08B 17/125

(57) ABSTRACT

Methods, systems, and apparatus, including computer programs encoded on computer storage media, for a multi-sensor fire monitoring system. One of the methods includes the actions of detecting, using data received from one or more sensors, a presence of a fire event in an area monitored by the one or more sensors; and in response to detecting the presence of the fire event: determining, using the data received from one or more sensors and, a fire classification of the fire event; selecting, from a plurality of automated actions for different types of fire classifications and using the fire classification of the fire event, one or more automated actions to execute; and executing the one or more automated actions.

### CROSS-REFERENCE TO RELATED APPLICATION

This application claims the benefit of U.S. Provisional Application No. 63/764,196, filed February 27, 2025, the contents of which are incorporated by reference herein.

### BACKGROUND

Fires pose significant risks to structures and individuals. The risks associated with fires can be mitigated using appropriate fire safety methods. Fire detection and suppression are approaches to fire safety which can mitigate these risks. Fire detection and suppression can use fire detection technologies to identify or indirectly reduce the presence of fires. In a multimodal system, different types of sensors are used together to determine the presence of a fire.

The fire detection systems and methods disclosed in this specification provide fire event detection and classification by using a variety of sensors. Such systems and methods can reduce false alarms, reduce fire event response times, increase response efficacy by determining a fire classification, or any combination of these. The fire detection system provides data from one or more sensors to an artificial intelligence module. The artificial intelligence module can provide a confirmation of the presence of a fire event, a categorization of the fire event, or a notification to a recipient before the system triggers an alarm.

In general, one innovative aspect of the subject matter described in this specification can be embodied in methods that include the actions of detecting, using data received from one or more sensors, a presence of a fire event in an area monitored by the one or more sensors; and in response to detecting the presence of the fire event: determining, using the data received from one or more sensors and, a fire classification of the fire event; selecting, from a plurality of automated actions for different types of fire classifications and using the fire classification of the fire event, one or more automated actions to execute; and executing the one or more automated actions.

Examples can include one or more of the following features. In some implementations, the method may include generating, in response to the presence of the fire event and the fire classification, a notification representing the presence of the fire event and the fire classification; determining at least one recipient; and transmitting the notification to the at least one recipient. Determining the fire classification may include inputting at least the data received from one or more sensors into an artificial intelligence module and receiving, from the artificial intelligence module, the fire classification. The artificial intelligence module may be a machine learning module trained to determine the fire classification using at least the data received from one or more sensors. Determining the at least one recipient may include receiving, from the artificial intelligence module, a list of recipients in response to the fire classification.

The method may include transmitting the notification to the at least one recipient may include transmitting the notification to the at least one recipient from the list of recipients received from the artificial intelligence module.

The method may include providing a notification to at least one recipient from the list of recipients, the notification may include information related to the fire event, or the fire classification. The list of recipients may include a person associated with an account to which the one or more sensors are registered, an emergency dispatch agent, or professional fire response agent. The method may include transmitting, to a fire control system and using the presence of the fire event and the fire classification, instructions to perform a fire control action.

The method may include determining, using the data received from the one or more sensors, a rate of change of the fire event. Determining the rate of change of the fire event may include receiving updated data from the one or more sensors and comparing the updated data to previously received data to determine the rate of change of the fire event.

The method may include changing the fire classification in response to the rate of change of the fire event to generate a second fire classification, selecting, from the plurality of automated actions, a second automated action using the second fire classification, wherein the second automated action is different than the one or more automated actions, and executing the second automated action.

The method may include transmitting a second notification to the recipient that is different than the notification or transmitting the notification or the second notification to a second recipient that is different than the recipient. Determining the rate of change of the fire event may include inputting the updated data into the artificial intelligence module and receiving, from the artificial intelligence module, the rate of change of the fire event. The rate of change may be a rate of change of a region of the fire event within the area monitored by the one or more sensors, a temperature rate of change, an intensity rate of change, a rate of change of smoke concentration, or a rate of change of one or more detected chemicals.

The method may include determining a classification of the area monitored by the one or more sensors, selecting, from the plurality of automated actions, the one or more automated actions using the classification of the area monitored by the one or more sensors.

The method may include generating the notification, using the presence of the fire event, the fire classification, and the classification of the area monitored by the one or more sensors. The classification may be a residential property, or a commercial property.

The method may include determining a subclassification of the area monitored by the one or more sensors. The subclassification may be different than the classification, and the subclassification may be a room type selected from a list which may include a bedroom, a living room, a kitchen, an electrical room, a basement room, or a well room and wherein generating the notification may be further using the subclassification of the area monitored by the one or more sensors. The one or more sensors may include a smoke detector, a heat detector, a flame sensor, a carbon monoxide sensor, a visible camera, or an infrared camera.

In general, one innovative aspect of the subject matter described in this specification can be embodied in a system, including one or more computers and one or more storage devices on which are stored instructions that are operable, when executed by the one or more computers, to cause the one or more computers to perform the method of any preceding aspect.

In general, one innovative aspect of the subject matter described in this specification can be embodied in one or more computer storage media encoded with instructions that, when executed by one or more computers, cause the one or more computers to perform the method of any of the aspects herein.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination.

The subject matter described in this specification can be implemented in various implementations and may result in one or more of the following advantages.

A fire monitoring system which monitors an area for fire events using multiple sensors can increase the safety of the monitored area. Using multiple sensors having overlapping and different sensing modalities can allow the fire monitoring system to determine the presence of the fire event rapidly and in adverse conditions (e.g., in walls or in high smoke).

Using multiple sensors having overlapping region monitoring and different sensing modalities can allow the fire monitoring system to reduce the instance of false alarms, e.g., such as smoke detectors exposed to high heat in the absence of a fire event.

The fire monitoring system determining the presence of the fire event can reduce the time required to perform an action to manage the fire event, e.g., thereby increasing safety, reducing the risk or potential cost of fire events, or any combination of these.

The fire monitoring system determining a fire classification can increase the accuracy of a fire response by providing the fire classification to emergency services. Thus, emergency responders have increased preparedness by employing tools, methods, or both, specific to the fire classification. Emergency responders can experience increased safety in their response due to a previous knowledge of the fire classification from the fire monitoring system.

The fire monitoring system determining the presence of the fire event using multiple sensors can reduce the monitoring costs, e.g., monetary, computational, or both, compared to other systems.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is schematic illustration of a fire monitoring system using one or more sensors to monitor an area.

FIG. 2 is a flow diagram of a process for the fire monitoring system.

FIG. 3 is a diagram illustrating an example of a property monitoring system.

Like reference numbers and designations in the various drawings indicate like elements.

### DETAILED DESCRIPTION

In some environments, detecting a fire event in real time and determining a fire classification using data from multiple sensors in parallel can be advantageous. Fire events are dangerous circumstances which can rapidly evolve, which can include expanding or changing characteristics using environmental circumstances. Different fire classifications, such as ordinary combustion or electrical fire events, involve different responses from professional response services. Detecting a fire event and determining the fire classification using data from multiple sensors can beneficially increase the safety of the environment by decreasing the time to generate an alarm, notify professional fire services, increase the likelihood of a corrective action sooner, or any combination of these.

Disclosed in this specification are systems and methods for detecting a fire event and determining a classification of the fire event using data received from one or more, e.g., multiple, sensors. Examples of the sensors include smoke detectors, heat detectors, flame sensors, carbon monoxide sensors, or cameras (e.g., visible or infrared (IR) cameras). In general, the system receives data from the multiple sensors in a monitored environment. The system processes the data through at least one algorithm to detect a fire event. The processing can include analysis of parameters of a fire event. Some examples of the fire event parameters can include a temperature, a chemical presence or concentration, a size, or an intensity. Some examples of analyzing the fire event including techniques such as color analysis, motion analysis, feature identification (e.g., a color, shape, or movement of detected flames, presence of smoke, or rapid changes in light intensity), or any combination of these.

The system classifies the detected fire event as having at least one fire classification. Fires can be classified into six main groups using the type of material that is burning such as ordinary combustibles, flammable liquids, flammable gases, metals, cooking oils or fats, or electricity. In some instances, a fire can have multiple classifications. The system compares the features of the fire to predefined criteria or with an artificial intelligence model, e.g., a pretrained artificial intelligence model, using previously classified fires.

The system monitors the fire event over time, such as monitoring one or more parameters of the fire event which changes as fire event spreads. Examples include a region of the fire event enlarging, changing temperature, changing visual or infrared intensity, changing chemical (e.g., smoke) concentration. The system generates notifications, or performs other automated actions, using the detected fire event, the determined rate of change, or the determined fire classification. The system determines one or more recipients to which to send the notifications, such as a homeowner, manager, emergency dispatch agent, or professional fire response agent. The system communicates the notification to the recipient to protect the environment from the detected fire event. In some examples, the system transmits instructions to a fire control system to perform a fire control action, such as activation of a sprinkler system or a CO₂ suppression system.

In a fire event detection system, different types of fire detectors can be used together, each contributing unique capabilities. A fire event detection system can integrate the data from these various sensors and apply sophisticated algorithms to confirm the presence of a fire before triggering an alarm.

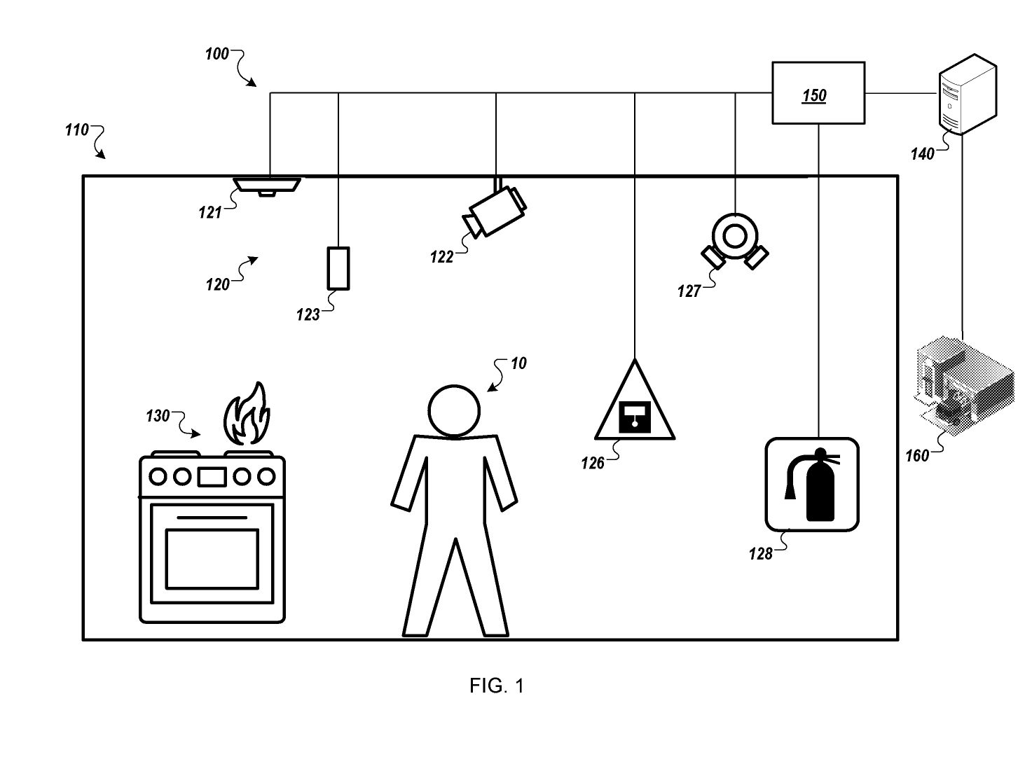

FIG. 1 is a schematic illustration of a fire monitoring system for an environment 100 that one or more sensors 120 to monitor an area 110. In the example of FIG. 1, the area 110 is a kitchen. The fire monitoring system, e.g., implemented on a controller 150, monitors the area 110 for a fire event 130. The fire monitoring system detects the presence of the fire event 130 using data received from one or more of the sensors 120. The fire monitoring system using data from more than one of the sensors 120 can increase the accuracy of fire event detection by reducing false positive fire event detection. The fire monitoring system can beneficially increase the safety of the area 110 by monitoring the area 110 in real time, actively detecting and categorizing the detected fire event 130 into a fire classification, and communicating notifications of the detected fire event 130 to connected systems.

The fire monitoring system uses data received from at least some of the sensors 120 to detect and determine a fire classification of the fire event 130 in the area 110. In FIG. 1, the fire event 130 is a grease fire on a stove within the area 110. The sensors 120 include a smoke sensor 121, and temperature sensor 123, and a camera sensor 122. Each of the sensors 120 generates data corresponding to the detection modality of the individual sensor. In some examples, the smoke sensor 121 generates data representing a presence, or a concentration, of one or more chemicals (e.g., smoke particulates, e.g., combustion products) in the area 110. In some examples, the temperature sensor 123 generates data representing a temperature, or a change in the temperature, of the area 110. Further examples of the data generated by the sensors 120 are described elsewhere in this specification.

The sensors 120 are communicatively coupled to a controller 150 of the fire monitoring system. Each of the sensors 120 transmits data generated by the respective sensor to the controller 150. The sensors 120 can transmit data continuously, intermittently, on a schedule of continuous or intermittent transmission, or any combination of these. For example, the sensors 120 can transmit data intermittently while the fire event 130 is not detected, and continuously when the fire event 130 is detected. In the example of FIG. 1, the smoke sensor 121 generates the data representing the fire event 130 to the controller 150. The data includes a concentration, or change in concentration, of smoke particulates in the area 110.

The sensors 120 include a camera sensor 122, e.g., an optical or an IR camera sensor. The camera sensor 122 generates image data in response to the field of view of the camera sensor 122. The camera sensor 122 transmits the image data to the controller 150 for determination of a fire event 130 in the field of view. The image data can include color information, intensity information, recording time information, or geographic information related to the field of view of the camera sensor 122. An IR camera generates image data in response to infrared radiation emitted in their field of view, e.g., in response to heat sources. An IR camera can generate image data in response to the infrared radiation where visible light from a heat source, e.g., fire event 130, might be obscured, such as in bright sunlight, areas with a visual obstruction (e.g., an electrical fire obscured by a wall, a fire event obscured by debris), or though smoke.

The controller 150 receives the data from the sensors 120, e.g., the data from the smoke sensor 121 representing the concentration of the smoke particulates. The controller 150 uses the data from the sensors 120 to determine the presence of the fire event 130, the fire classification of the fire event 130, or both, e.g., the controller 150 uses the smoke particulate data received from the smoke sensor 121 to detect the fire event 130.

The controller 150 stores a classification, a subclassification, or both, of the area 110 in which each of the sensors 120 is located. Non-limiting examples of the classification of the area 110 can include residential (e.g., a home, apartment, or condominium), commercial (e.g., a restaurant, office space, or mall), or an industrial classification (e.g., a manufacturing space). The controller 150 can store a subclassification for each of the respective classifications. The subclassification can be a subcategory of the umbrella classification. The controller 150 can store different responses to different classifications or subclassifications depending on the content or fire dangers of the classification, the subclassification, or both. Non-limiting examples of residential subclassifications a bedroom, a living room, a kitchen, an electrical room, a basement room, or a well room.

The controller 150 includes, or is communicatively coupled to, a fire analytics module. The fire analytics module receives data from the controller 150 to determine one or more parameters of the fire event 130. The fire analytics module receives input data related to one or more fire events and outputs one or more parameters of the fire events, such the fire classification, a fire intensity, or a region of the area 110 in which the fire event 130 is located, or a combination thereof. The input data can be some of the sensor data generated by the sensors 120.

The fire analytics module can be an artificial intelligence module, e.g., a machine learning module. The artificial intelligence module can be trained to determine one or more parameters of fire event. The artificial intelligence module can be pre-trained or actively trained using supervised or unsupervised methods. The artificial intelligence module can include one or more sub-modules for processing received data. For example, the artificial intelligence module can include a machine vision engine which receives image data and outputs fire parameters using the image data. Some examples include a convolutional neural network (CNN)(e.g., 3D CNNs), or a recurrent neural network (RNN) for processing image data.

In some examples, the fire analytics module can be trained using publicly available data or libraries. Some examples of training modules which can be used to train the fire analytics module include TensorFlow (tensorflow.org), PyTorch (pytorch.org), or PaddlePaddle (github.com/paddlepaddle). The fire analytics module can be trained using publicly available video data (e.g., YouTube video data of fires or flames), or image data (e.g., Fire Luminosity Airborne-based Machine learning Evaluation (FLAME) dataset).

The fire analytics module can include a machine vision engine. The machine vision engine receives video data from the camera sensor 122 monitoring the area 110. The machine vision engine processes one or more video frames, or data representing video frames, using one or more video processing algorithm to analyze the video data. Some implementations of the machine vision engine process the video data using color analysis algorithm, a motion analysis algorithm, or both.

The machine vision engine identifies features in the video data that indicate the fire event 130. Features of the fire event 130 can include a color, a shape, a movement, a presence of smoke, a pattern of smoke, a light intensity, or a combination of these. The machine vision engine can identify the presence of one or more features, a change in one or more features (e.g., a spread of the fire event 130), a rate of change of one or more features (e.g., a rate of spread of the fire event 130), or a combination of these.

The fire analytics module classifies the identified features to determine whether they indicate a fire event. The fire analytics module can compare the features to predefined criteria or fire event models of fire events on which the machine vision engine was trained. The system uses machine learning techniques to learn and adapt the fire event models using training data, video data received from the camera sensor 122, or other data from the sensors 120.

The fire analytics module receives data generated by at least some of, potentially all of, the sensors 120 representing the fire event 130 in the area 110. In some instances, some of the sensor data might not represent the fire event 130, e.g., when the fire event has not spread throughout the area or any particular one of the sensors 120 is unable to capture sensor data representing the fire event. The fire analytics module determines a fire classification of the fire event 130 according to the received data.

The fire analytics module can determine the fire classification from two or more fire classifications. Some examples of fire classifications include Class A (e.g., burning solids such as paper, wood, or structural elements of buildings), Class B (e.g., burning liquids such as chemicals, alcohol, oil, solvents, paints, fuels, and other explosive fluids), Class C (e.g., flammable gases such as propane or butane), Class D (e.g., burning metals which can conduct heat quickly, like sodium, titanium, or potassium), electrical (e.g., broken wiring or overloaded circuits), or Class K fires (e.g., burning oils, fats, or greases). In some instances, a fire can have multiple classifications.

The fire analytics module determines one or more features of the fire event 130 using the received data. The fire analytics module determines a color, region of the area 110 in which the fire event 130 is located, movement of detected flames (e.g., spreading of the fire event 130), presence or density of smoke (e.g., a concentration of smoke particulates or an amount of visual obstruction of the fire event 130), rapid changes in light intensity (e.g., a flare or explosion), or any combination of these. A rapid change in light intensity can be a change in light intensity that satisfies a change threshold.

The controller 150 receives the fire classification from the artificial intelligence module. The controller 150 can maintain a list of automated actions to execute for different types of fire classifications, e.g., a lookup table, or file containing a list. The controller 150 can select at least one of the automated actions to execute from the list of automated actions using the received fire classification. Some examples of the list of automated actions include communicating instructions to a fire control system, or communicating a notification to one or more emergency services. In some examples, the controller 150 can provide a notification to one or more emergency services, or one or more devices, or both, independently from selecting at least one of the automated actions to execute.

The controller 150 is communicatively coupled to one or more fire control systems. The controller 150 provides instructions to the fire control systems using the data received from the sensors 120, the fire analytics module, or both. The controller 150 transmits instructions to one or more systems of the fire control systems once the controller 150 detects the fire event 130 in the area 110 and receives the fire classification from the artificial intelligence module.

The fire control systems shown in the area 110 are non-limiting examples and include a fire alarm 126, a fire suppression system 127, and a fire suppression station 128. The controller 150 can send instructions to the fire alarm 126 to produce a notification indicating the fire event 130 in the area 110, e.g., an auditory notification, including a verbal notification, a light notification, or a combination thereof.

The fire suppression system 127 includes one or more dispensers fluidically coupled to a fire suppression fluid network, e.g., water, e.g., a sprinkler system. The controller 150 can send instructions to the fire suppression system 127 to dispense fire suppression fluid in the area 110. The fire suppression system 127 dispenses the fire suppression fluid in response to the instructions.

The fire suppression station 128 is a fire extinguisher unit, e.g., a fire extinguisher operable by the person 10. The controller 150 can send instructions to the fire suppression station 128 to prepare the fire extinguisher unit for operation by the person 10.

In some examples, the fire suppression station 128 includes an enclosure having a door, a notification system, or both. The controller 150 can send instructions to the fire suppression station 128 to unlock or open the door, generate a notification from the notification system, or both. The notification can be an audio, or light notification indication the presence or location of the fire suppression station 128. Examples of the fire suppression station 128 include a dry powder extinguisher, a foam spray extinguisher, a liquid (e.g., water) extinguisher, a gas (e.g., CO₂) extinguisher, or a fire hose reel. In some implementations, the controller 150 can send instructions to a type of fire suppression station 128 which corresponds with the fire category, e.g., a CO₂ extinguisher for a grease fire and not a fire hose reel.

The controller 150 generates a notification upon detecting of the fire event 130, determination of the fire classification, or both. The fire monitoring system generates a notification that is understandable by a person (e.g., a text or video notification), a computer system (e.g., a computer command), or both. The fire monitoring system communicates the notification to a device responsive to the notification. For example, the fire monitoring system generates a notification that, when received by a mobile device, causes the mobile device to display a text message within the notification.

In some implementations, the controller 150 generates a notification using the fire classification. In some examples in which the controller 150 determines that that fire event 130 is a grease fire, the controller 150 generates a notification which includes information on a safe means of extinguishing the grease fire, e.g., use a powder or a CO₂ extinguisher, e.g., do not use a water-based extinguishing method.

In some examples, the controller 150 automatically alerts local emergency services upon detecting the fire event 130 in the area 110. The controller 150 is communicatively coupled to a central alarm system 140. The central alarm system 140 is a system of one or more computers which provide alarm services for the environment 100 including the area 110 and other areas, e.g., for multiple properties. The central alarm system 140 is communicatively coupled with emergency services 160 related to the area 110. For example, the emergency services 160 can be local emergency services for a residential property in a residential neighborhood. The local emergency services can include emergency dispatch service, fire services, law enforcement services, health services (e.g., emergency medical services), or a combination thereof.

In some examples, the controller 150 can communicate directly with the emergency services 160. The controller 150 can communicate a notification to automated systems of the emergency services 160, or a notification to one or more agents of the emergency services 160.

The central alarm system 140 can provide data received from the controller 150 to the emergency services 160. The data provided to the emergency services 160 can include data related to the fire event 130, the area 110, the person 10, data received from the sensors 120, or a combination thereof. For example, the central alarm system 140 can provide a geographic location of the area 110, the determined fire classification, data related to fire suppression system 127 of the area 110, or a combination thereof.

The fire monitoring system can monitor residential or commercial areas. The fire monitoring system can monitor multiple areas within a larger complex, e.g., an apartment building or condominium complex. Examples of residential areas for monitoring by the fire monitoring system include but are not limited to houses, apartments, or condominiums. Examples of commercial areas for monitoring by the fire monitoring system include commercial storage areas, restaurants, business parks, or malls.

When the area 110 is part of an apartment complex, the fire monitoring system can monitor at least one of the apartments in the complex and communicate with a fire suppression system installed in the complex. The fire monitoring system can be communicatively coupled with a network (e.g., a telephone network, a fiber optic network, or a coaxial network), a fire suppression system, or a fire alarm system of the complex (e.g., via a wired or a wireless network connection). The fire monitoring system can use the telecommunications network of the complex to communicate with emergency services 160 associated with the complex. The fire monitoring system can provide instructions to the fire suppression system or the fire alarm system of the complex to activate either system.

Examples of commercial areas include malls, e.g., strip malls, manufacturing facilities, or data centers. A mall, e.g., a strip mall, can include a security panel with different partitions for each individual store. The fire monitoring system can monitor one store, or multiple individual stores from an area that includes the security panel. The fire monitoring system can monitor manufacturing facilities where machinery overheating and electrical faults could be detected in one or more areas of the manufacturing facilities. The fire monitoring system can monitor a data centers to prevent damage to IT infrastructure.

The fire monitoring system uses the signals received from the sensors 120 to detect the presence and determine the type of the fire event 130 in the area 110. Some implementations of the fire monitoring system include a heat detector. A heat detector generates a signal in response to a rapid rise in temperature or a temperature that exceeds a predetermined threshold. Heat detectors can be used in combination with the other sensors in environments where the other sensors may give false alarms, such as kitchens or areas with high dust levels.

Some implementations of the fire monitoring system include a flame sensor. Flame sensors detect the light produced by a fire event. Flame sensors can detect infrared light or ultraviolet light produced by the fire event. Flame sensors have short detection times and are beneficial in situations where smoke or heat may not be immediately detectable, such as outdoor areas, wall cavities, or high-ceiling spaces.

Some implementations of the fire monitoring system include a carbon monoxide sensor. Carbon monoxide sensors detect the presence of carbon monoxide. A fire event 130 produces carbon monoxide during combustion. Carbon monoxide sensors can reduce detection time of a fire event by determining the presence or concentration of carbon monoxide present before smoke or flames are visible.

The controller 150 is an example of a system implemented as computer programs on one or more computers in one or more locations, in which the systems, components, and techniques described in this specification are implemented. The network (not shown), such as a local area network (“LAN”), wide area network (“WAN”), the Internet, or a combination thereof, connects, the controller 150, the sensors 120, the one or more fire control systems, central alarm system 140, and the emergency services 160. The controller 150 can use a single computer or multiple computers operating in conjunction, including, for example, a set of remote computers deployed as a cloud computing service.

The controller 150 can include several different functional components, including the fire analytics module, the artificial intelligence module, and the machine vision engine. Any one or more of the components can include one or more data processing apparatuses, can be implemented in code, or a combination of both. For instance, each of the components can include one or more data processors and instructions that cause the one or more data processors to perform the operations discussed in this specification.

The various functional components of the controller 150 can be installed on one or more computers as separate functional components or as different modules of a same functional component. For example, the controller 150 components can be implemented as computer programs installed on one or more computers in one or more locations that are coupled to each through a network. In cloud-based systems for example, these components can be implemented by individual computing nodes of a distributed computing system.

For situations in which the systems discussed here collect personal information about people, or may make use of personal information, the people may be provided with an opportunity to control whether programs or features collect personal information (e.g., information about a person’s activities, a person’s preferences, or a person’s current location), or to control whether and/or how the system operates. In addition, certain data may be anonymized in one or more ways before it is stored or used, so that personally identifiable information is removed. For example, a person’s identity may be anonymized so that no personally identifiable information can be determined for the person. Thus, the person may have control over how information is collected about them and used.

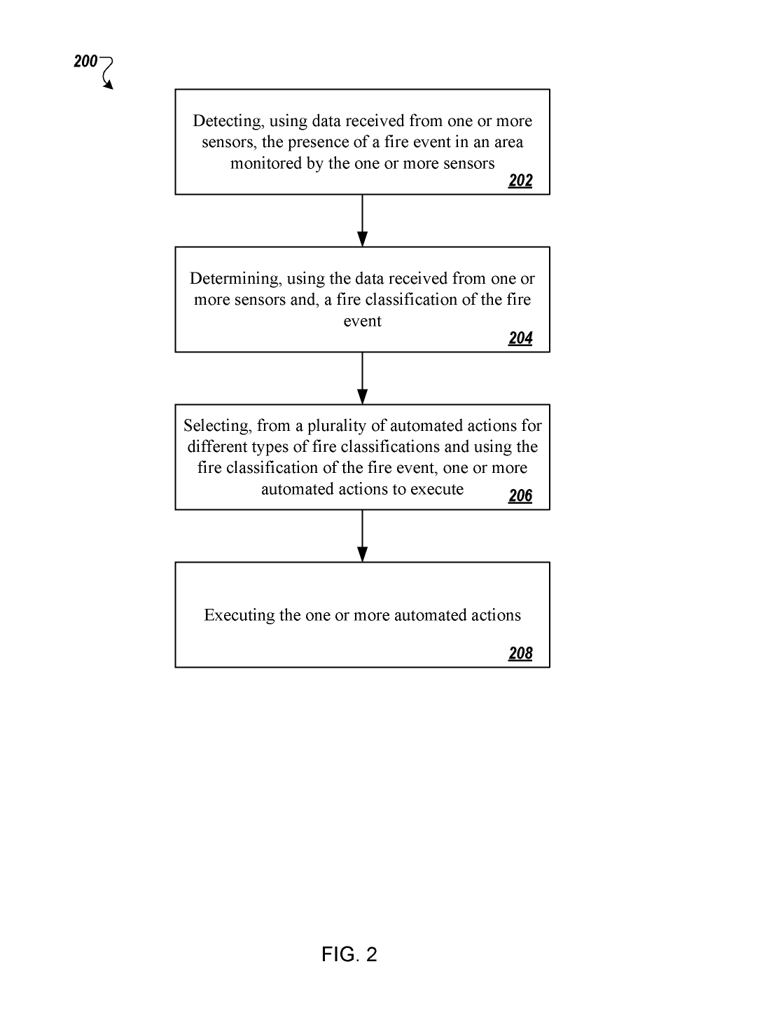

FIG. 2 is a flow diagram of a process 200 for the fire monitoring system. For example, the process 200 can be used by the fire monitoring system when monitoring the area 110.

A system coupled to one or more sensors monitors an area for the presence of a fire event. The system detects, using data received from one or more sensors, the presence of a fire event in an area monitored by the one or more sensors (202). The system receives the data from the one or more sensors. The system processes the received data to detect the presence of the fire event.

The system determines, using the data received from one or more sensors and, a fire classification of the fire event (204). The system can include an artificial intelligence module trained to detect the presence of the fire event, to determine features of the detected fire event, determine a fire classification using the determined features, or any combination of these.

The artificial intelligence module can include one or more sub-engines like a machine vision engine. The machine vision engine receives video data from one or more of the sensors. The machine vision engine processes the video data to determine one or more features of the detected fire event present in the video data. The machine vision engine provides the determined features of the detected fire event to the artificial intelligence module. The artificial intelligence model uses the determined featured to classify the fire event.

The system selects, from a list of automated actions for different types of fire classifications and using the fire classification of the fire event, one or more automated actions to execute (206). The system maintains, e.g., stores, in a database a list of automated actions, each action corresponding to one or more fire classifications of the fire event. The system selects one or more action in response to the detection of the fire event and receiving the fire classification from the artificial intelligence module.

The system executes the one or more automated actions (208). In some implementations, the system generates a notification, communicates instructions, or activates one or more fire control systems.

The order of operations in the process 200 described above is illustrative only and can be performed in different orders. For example, the system can detect a fire event and perform one or more automated actions before receiving the fire classification from the artificial intelligence module. The system can then perform a different one or more automated actions in response to receiving the fire classification.

In some implementations, the process 200 can include additional operations, fewer operations, or some of the operations can be divided into multiple operations.

In this specification, the term “database” is used broadly to refer to any collection of data: the data does not need to be structured in any particular way, or structured at all, and it can be stored on storage devices in one or more locations. A database can be implemented on any appropriate type of memory.

In this specification the term “engine” or “module” is used broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

Operations can occur substantially concurrently in that the operations need not be exactly concurrent but can overlap at least in part. For instance, a first operation can begin and sometime after that a second operation can begin while the first operation is still occurring. Execution of the two operations, whether by the same system or different systems, can be substantially concurrently. In some examples, two operations can execute substantially concurrently when they have the same start time, same end time, or both.

In this specification, the term likely is used to mean that there is a likelihood that something might occur, and that likelihood satisfies a likelihood threshold. For instance, when determining that a fire event 130 is likely depicted in an image, a system would determine a likelihood that the fire event 130 is depicted in the image. The system would then determine whether the likelihood satisfies, e.g., is greater than or equal to, a likelihood threshold by comparing the two values. If so, the system determines that the fire event 130 is likely depicted in the image. If not, the system determines that the fire event 130 is not likely depicted in the image.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

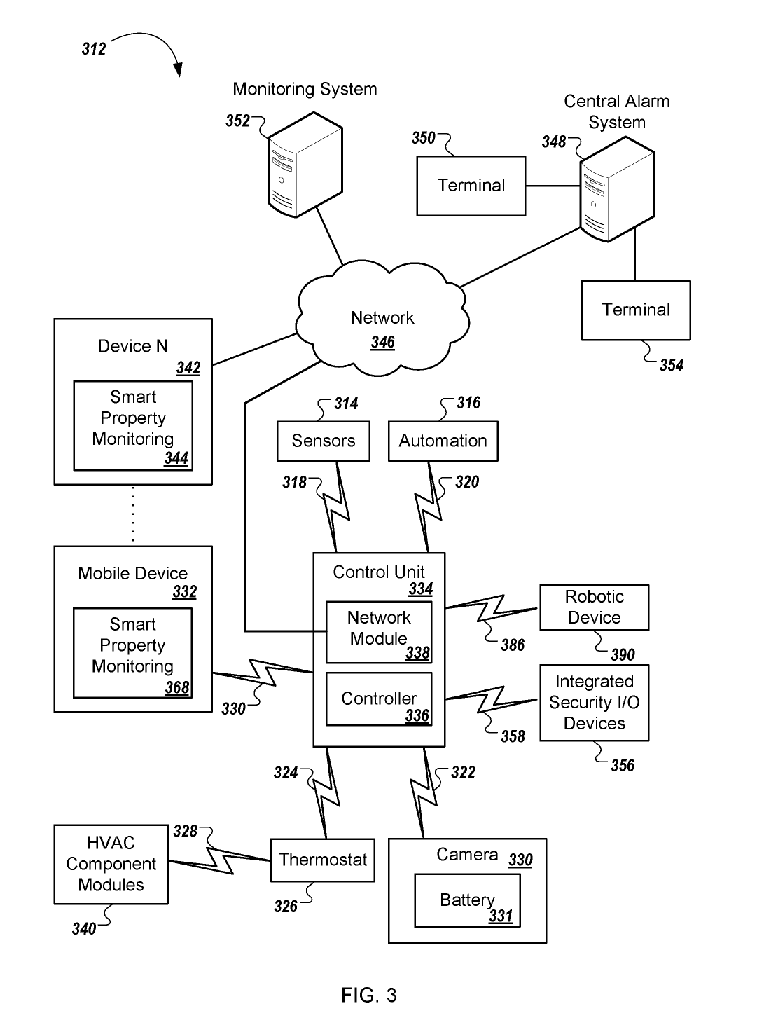

FIG. 3 is a diagram illustrating an example of an environment 300, e.g., for monitoring a property. The property can be any appropriate type of property, such as a home, a business, or a combination of both. The environment 300 includes a network 305, a control unit 310, one or more devices 340 and 350, a monitoring system 360, a central alarm system 370, or a combination of two or more of these. In some examples, the network 305 facilitates communications between two or more of the control unit 310, the one or more devices 340 and 350, the monitoring system 360, and the central alarm system 370.

The network 305 is configured to enable exchange of electronic communications between devices connected to the network 305. For example, the network 305 can be configured to enable exchange of electronic communications between the control unit 310, the one or more devices 340 and 350, the monitoring system 360, and the central alarm system 370. The network 305 can include, for example, one or more of the Internet, Wide Area Networks (“WANs”), Local Area Networks (“LANs”), analog or digital wired and wireless telephone networks (e.g., a public switched telephone network (“PSTN”), Integrated Services Digital Network (“ISDN”), a cellular network, and Digital Subscriber Line (“DSL”)), radio, television, cable, satellite, any other delivery or tunneling mechanism for carrying data, or a combination of these. The network 305 can include multiple networks or subnetworks, each of which can include, for example, a wired or wireless data pathway. The network 305 can include a circuit-switched network, a packet-switched data network, or any other network able to carry electronic communications (e.g., data or voice communications). For example, the network 305 can include networks based on the Internet protocol (“IP”), asynchronous transfer mode (“ATM”), the PSTN, packet-switched networks based on IP, X.25, or Frame Relay, or other comparable technologies and can support voice using, for example, voice over IP (“VoIP”), or other comparable protocols used for voice communications. The network 305 can include one or more networks that include wireless data channels and wireless voice channels. The network 305 can be a broadband network.

The control unit 310 includes a controller 312 and a network module 314. The controller 312 is configured to control a control unit monitoring system, e.g., a control unit system, which includes the control unit 310. In some examples, the controller 312 can include one or more processors or other control circuitry configured to execute instructions of a program that controls operation of a control unit system. In these examples, the controller 312 can be configured to receive input from sensors, or other devices included in the control unit system and control operations of devices at the property, e.g., speakers, displays, lights, doors, other appropriate devices, or a combination of these. For example, the controller 312 can be configured to control operation of the network module 314 included in the control unit 310.

The network module 314 is a communication device configured to exchange communications over the network 305. The network module 314 can be a wireless communication module configured to exchange wireless, wired, or a combination of both, communications over the network 305. For example, the network module 314 can be a wireless communication device configured to exchange communications over a wireless data channel and a wireless voice channel. In some examples, the network module 314 can transmit alarm data over a wireless data channel and establish a two-way voice communication session over a wireless voice channel. The wireless communication device can include one or more of a LTE module, a GSM module, a radio modem, a cellular transmission module, or any type of module configured to exchange communications in any appropriate type of wireless or wired format.

The network module 314 can be a wired communication module configured to exchange communications over the network 305 using a wired connection. For instance, the network module 314 can be a modem, a network interface card, or another type of network interface device. The network module 314 can be an Ethernet network card configured to enable the control unit 310 to communicate over a local area network, the Internet, or a combination of both. The network module 314 can be a voice band modem configured to enable the alarm panel to communicate over the telephone lines of Plain Old Telephone Systems (“POTS”).

The control unit system that includes the control unit 310 can include one or more sensors 320. For example, the environment 300 can include multiple sensors 320. The sensors 320 can include a lock sensor, a contact sensor, a motion sensor, a camera (e.g., a camera 330), a flow meter, any other type of sensor included in a control unit system, or a combination of two or more of these. The sensors 320 can include an environmental sensor, such as a temperature sensor, a water sensor, a rain sensor, a wind sensor, a light sensor, a smoke detector, a carbon monoxide detector, or an air quality sensor, to name a few additional examples. The sensors 320 can include a health monitoring sensor, such as a prescription bottle sensor that monitors taking of prescriptions, a blood pressure sensor, a blood sugar sensor, or a bed mat configured to sense presence of liquid (e.g., bodily fluids) on the bed mat. In some examples, the health monitoring sensor can be a wearable sensor that attaches to a person, e.g., a user, at the property. The health monitoring sensor can collect various health data, including pulse, heartrate, respiration rate, sugar or glucose level, bodily temperature, motion data, or a combination of these. The sensors 320 can include a radio-frequency identification (“RFID”) sensor that identifies a particular article that includes a pre-assigned RFID tag.

The control unit 310 can communicate with a module 322 and a camera 330 to perform monitoring. The module 322 is connected to one or more devices that enable property automation, e.g., home or business automation. For instance, the module 322 can connect to, and be configured to control operation of, one or more lighting systems. The module 322 can connect to, and be configured to control operation of, one or more electronic locks, e.g., control Z-Wave locks using wireless communications in the Z-Wave protocol. In some examples, the module 322 can connect to, and be configured to control operation of, one or more appliances. The module 322 can include multiple sub-modules that are each specific to a type of device being controlled in an automated manner. The module 322 can control the one or more devices using commands received from the control unit 310. For instance, the module 322 can receive a command from the control unit 310, which command was sent using data captured by the camera 330 that depicts an area. In response, the module 322 can cause a lighting system to illuminate an area to provide better lighting in the area, and a higher likelihood that the camera 330 can capture a subsequent image of the area that depicts more accurate data of the area.

The camera 330 can be an image camera or other type of optical sensing device configured to capture one or more images. For instance, the camera 330 can be configured to capture images of an area within a property monitored by the control unit 310. The camera 330 can be configured to capture single, static images of the area; video of the area, e.g., a sequence of images; or a combination of both. The sequence of images can be a sequence of frames, e.g., when the video is compressed using a video codec. The image captured by the camera can be any appropriate type of image, e.g., a frame. The camera 330 can be controlled using commands received from the control unit 310 or another device in the property monitoring system, e.g., a device 350.

The camera 330 can be triggered using any appropriate techniques, can capture images continuously, or a combination of both. For instance, a Passive Infra-Red (“PIR”) motion sensor can be built into the camera 330 and used to trigger the camera 330 to capture one or more images when motion is detected. The camera 330 can include a microwave motion sensor built into the camera which is used to trigger the camera 330 to capture one or more images when motion is detected. The camera 330 can have a “normally open” or “normally closed” digital input that can trigger capture of one or more images when external sensors detect motion or other events. The external sensors can include another sensor from the sensors 320, PIR, or door or window sensors, to name a few examples. In some implementations, the camera 330 receives a command to capture an image, e.g., when external devices detect motion or another potential alarm event or in response to a request from a device. The camera 330 can receive the command from the controller 312, directly from one of the sensors 320, or a combination of both.

In some examples, the camera 330 triggers integrated or external illuminators to improve image quality when the scene is dark. Some examples of illuminators can include Infra-Red, Z-wave controlled “white” lights, lights controlled by the module 322, or a combination of these. An integrated or separate light sensor can be used to determine if illumination is desired and can result in increased image quality.

The camera 330 can be programmed with any combination of time schedule, day schedule, system “arming state”, other variables, or a combination of these, to determine whether images should be captured when one or more triggers occur. The camera 330 can enter a low-power mode when not capturing images. In this case, the camera 330 can wake periodically to check for inbound messages from the controller 312 or another device. The camera 330 can be powered by internal, replaceable batteries, e.g., if located remotely from the control unit 310. The camera 330 can employ a small solar cell to recharge the battery when light is available. The camera 330 can be powered by a wired power supply, e.g., the controller’s 312 power supply if the camera 330 is co-located with the controller 312.

In some implementations, the camera 330 communicates directly with the monitoring system 360 over the network 305. In these implementations, image data captured by the camera 330 need not pass through the control unit 310. The camera 330 can receive commands related to operation from the monitoring system 360, provide images to the monitoring system 360, or a combination of both.

The environment 300 can include one or more thermostats 334, e.g., to perform dynamic environmental control at the property. The thermostat 334 is configured to monitor temperature of the property, energy consumption of a heating, ventilation, and air conditioning (“HVAC”) system associated with the thermostat 334, or both. In some examples, the thermostat 334 is configured to provide control of environmental (e.g., temperature) settings. In some implementations, the thermostat 334 can additionally or alternatively receive data relating to activity at a property; environmental data at a property, e.g., at various locations indoors or outdoors or both at the property; or a combination of both. The thermostat 334 can measure or estimate energy consumption of the HVAC system associated with the thermostat. The thermostat 334 can estimate energy consumption, for example, using data that indicates usage of one or more components of the HVAC system associated with the thermostat 334. The thermostat 334 can communicate various data, e.g., temperature, energy, or both, with the control unit 310. In some examples, the thermostat 334 can control the environment, e.g., temperature, settings in response to commands received from the control unit 310.

In some implementations, the thermostat 334 is a dynamically programmable thermostat and can be integrated with the control unit 310. For example, the dynamically programmable thermostat 334 can include the control unit 310, e.g., as an internal component to the dynamically programmable thermostat 334. In some examples, the control unit 310 can be a gateway device that communicates with the dynamically programmable thermostat 334. In some implementations, the thermostat 334 is controlled via one or more modules 322.

The environment 300 can include the HVAC system or otherwise be connected to the HVAC system. For instance, the environment 300 can include one or more HVAC modules 337. The HVAC modules 337 can be connected to one or more components of the HVAC system associated with a property. A module 337 can be configured to capture sensor data from, control operation of, or both, corresponding components of the HVAC system. In some implementations, the module 337 is configured to monitor energy consumption of an HVAC system component, for example, by directly measuring the energy consumption of the HVAC system components or by estimating the energy usage of the one or more HVAC system components by detecting usage of components of the HVAC system. The module 337 can communicate energy monitoring information, the state of the HVAC system components, or both, to the thermostat 334. The module 337 can control the one or more components of the HVAC system in response to receipt of commands received from the thermostat 334.

In some examples, the environment 300 includes one or more robotic devices 390. The robotic devices 390 can be any type of robots that are capable of moving, such as an aerial drone, a land-based robot, or a combination of both. The robotic devices 390 can take actions, such as capture sensor data or other actions that assist in security monitoring, property automation, or a combination of both. For example, the robotic devices 390 can include robots capable of moving throughout a property using automated navigation control technology, user input control provided by a user, or a combination of both. The robotic devices 390 can fly, roll, walk, or otherwise move about the property. The robotic devices 390 can include helicopter type devices (e.g., quad copters), rolling helicopter type devices (e.g., roller copter devices that can fly and roll along the ground, walls, or ceiling) and land vehicle type devices (e.g., automated cars that drive around a property). In some examples, the robotic devices 390 can be robotic devices 390 that are intended for other purposes and merely associated with the environment 300 for use in appropriate circumstances. For instance, a robotic vacuum cleaner device can be associated with the environment 300 as one of the robotic devices 390 and can be controlled to take action responsive to monitoring system events.

In some examples, the robotic devices 390 automatically navigate within a property. In these examples, the robotic devices 390 include sensors and control processors that guide movement of the robotic devices 390 within the property. For instance, the robotic devices 390 can navigate within the property using one or more cameras, one or more proximity sensors, one or more gyroscopes, one or more accelerometers, one or more magnetometers, a global positioning system (“GPS”) unit, an altimeter, one or more sonar or laser sensors, any other types of sensors that aid in navigation about a space, or a combination of these. The robotic devices 390 can include control processors that process output from the various sensors and control the robotic devices 390 to move along a path that reaches the desired destination, avoids obstacles, or a combination of both. In this regard, the control processors detect walls or other obstacles in the property and guide movement of the robotic devices 390 in a manner that avoids the walls and other obstacles.

In some implementations, the robotic devices 390 can store data that describes attributes of the property. For instance, the robotic devices 390 can store a floorplan, a three-dimensional model of the property, or a combination of both, that enable the robotic devices 390 to navigate the property. During initial configuration, the robotic devices 390 can receive the data describing attributes of the property, determine a frame of reference to the data (e.g., a property or reference location in the property), and navigate the property using the frame of reference and the data describing attributes of the property. In some examples, initial configuration of the robotic devices 390 can include learning one or more navigation patterns in which a user provides input to control the robotic devices 390 to perform a specific navigation action (e.g., fly to an upstairs bedroom and spin around while capturing video and then return to a property charging base). In this regard, the robotic devices 390 can learn and store the navigation patterns such that the robotic devices 390 can automatically repeat the specific navigation actions upon a later request.

In some examples, the robotic devices 390 can include data capture devices. In these examples, the robotic devices 390 can include, as data capture devices, one or more cameras, one or more motion sensors, one or more microphones, one or more biometric data collection tools, one or more temperature sensors, one or more humidity sensors, one or more air flow sensors, any other type of sensor that can be useful in capturing monitoring data related to the property and users in the property, or a combination of these. The one or more biometric data collection tools can be configured to collect biometric samples of a person in the property with or without contact of the person. For instance, the biometric data collection tools can include a fingerprint scanner, a hair sample collection tool, a skin cell collection tool, or any other tool that allows the robotic devices 390 to take and store a biometric sample that can be used to identify the person (e.g., a biometric sample with DNA that can be used for DNA testing).

In some implementations, the robotic devices 390 can include output devices. In these implementations, the robotic devices 390 can include one or more displays, one or more speakers, any other type of output devices that allow the robotic devices 390 to communicate information, e.g., to a nearby user or another type of person, or a combination of these.

The robotic devices 390 can include a communication module that enables the robotic devices 390 to communicate with the control unit 310, each other, other devices, or a combination of these. The communication module can be a wireless communication module that allows the robotic devices 390 to communicate wirelessly. For instance, the communication module can be a Wi-Fi module that enables the robotic devices 390 to communicate over a local wireless network at the property. Other types of short-range wireless communication protocols, such as 900 MHz wireless communication, Bluetooth, Bluetooth LE, Z-wave, Zigbee, Matter, or any other appropriate type of wireless communication, can be used to allow the robotic devices 390 to communicate with other devices, e.g., in or off the property. In some implementations, the robotic devices 390 can communicate with each other or with other devices of the environment 300 through the network 305.

The robotic devices 390 can include processor and storage capabilities. The robotic devices 390 can include any one or more suitable processing devices that enable the robotic devices 390 to execute instructions, operate applications, perform the actions described throughout this specification, or a combination of these. In some examples, the robotic devices 390 can include solid-state electronic storage that enables the robotic devices 390 to store applications, configuration data, collected sensor data, any other type of information available to the robotic devices 390, or a combination of two or more of these.

The robotic devices 390 can process captured data locally, provide captured data to one or more other devices for processing, e.g., the control unit 310 or the monitoring system 360, or a combination of both. For instance, the robotic device 390 can provide the images to the control unit 310 for processing. In some examples, the robotic device 390 can process the images to determine an identification of the items.

One or more of the robotic devices 390 can be associated with one or more charging stations. The charging stations can be located at a predefined home base or reference location in the property. The robotic devices 390 can be configured to navigate to one of the charging stations after completion of one or more tasks needed to be performed, e.g., for the environment 300. For instance, after completion of a monitoring operation or upon instruction by the control unit 310, a robotic device 390 can be configured to automatically fly to and connect with, e.g., land on, one of the charging stations. In this regard, a robotic device 390 can automatically recharge one or more batteries included in the robotic device 390 so that the robotic device 390 is less likely to need recharging when the environment 300 requires use of the robotic device 390, e.g., absent other concerns for the robotic device 390.

The charging stations can be contact-based charging stations, wireless charging stations, or a combination of both. For contact-based charging stations, the robotic devices 390 can have readily accessible points of contact to which a robotic device 390 can contact on the charging station. For instance, a helicopter type robotic device can have an electronic contact on a portion of its landing gear that rests on and couples with an electronic pad of a charging station when the helicopter type robotic device lands on the charging station. The electronic contact on the robotic device 390 can include a cover that opens to expose the electronic contact when the robotic device is charging and closes to cover and insulate the electronic contact when the robotic device 390 is in operation.

For wireless charging stations, the robotic devices 390 can charge through a wireless exchange of power. In these instances, a robotic device 390 needs only position itself closely enough to a wireless charging station for the wireless exchange of power to occur. In this regard, the positioning needed to land at a predefined home base or reference location in the property can be less precise than with a contact-based charging station. Based on the robotic devices 390 landing at a wireless charging station, the wireless charging station can output a wireless signal that the robotic device 390 receives and converts to a power signal that charges a battery maintained on the robotic device 390. As described in this specification, a robotic device 390 landing or coupling with a charging station can include a robotic device 390 positioning itself within a threshold distance of a wireless charging station such that the robotic device 390 is able to charge its battery.

In some implementations, one or more of the robotic devices 390 has an assigned charging station. In these implementations, the number of robotic devices 390 can equal the number of charging stations. In these implementations, the robotic devices 390 can always navigate to the specific charging station assigned to that robotic device 390. For instance, a first robotic device can always use a first charging station and a second robotic device can always use a second charging station.

In some examples, the robotic devices 390 can share charging stations. For instance, the robotic devices 390 can use one or more community charging stations that are capable of charging multiple robotic devices 390, e.g., substantially concurrently or separately or a combination of both at different times. The community charging station can be configured to charge multiple robotic devices 390 at substantially the same time, e.g., the community charging station can begin charging a first robotic device and then, while charging the first robotic device, begin charging a second robotic device five minutes later. The community charging station can be configured to charge multiple robotic devices 390 in serial such that the multiple robotic devices 390 take turns charging and, when fully charged, return to a predefined home base or reference location or another location in the property that is not associated with a charging station. The number of community charging stations can be less than the number of robotic devices 390.

In some instances, the charging stations might not be assigned to specific robotic devices 390 and can be capable of charging any of the robotic devices 390. In this regard, the robotic devices 390 can use any suitable, unoccupied charging station when not in use, e.g., when not performing an operation for the environment 300. For instance, when one of the robotic devices 390 has completed an operation or is in need of battery charge, the control unit 310 can reference a stored table of the occupancy status of each charging station and instructs the robotic device to navigate to the nearest charging station that has at least one unoccupied charger.

The environment 300 can include one or more integrated security devices 380. The one or more integrated security devices can include any type of device used to provide alerts based on received sensor data. For instance, the one or more control units 310 can provide one or more alerts to the one or more integrated security input/output devices 380. In some examples, the one or more control units 310 can receive sensor data from the sensors 320 and determine whether to provide an alert, or a message to cause presentation of an alert, to the one or more integrated security input/output devices 380.

The sensors 320, the module 322, the camera 330, the thermostat 334, the module 337, the integrated security devices 380, and the robotic devices 390, can communicate with the controller 312 over communication links 324, 326, 328, 332, 336, 338, 384, and 386. The communication links 324, 326, 328, 332, 336, 338, 384, and 386 can be a wired or wireless data pathway configured to transmit signals between any combination of the sensors 320, the module 322, the camera 330, the thermostat 334, the module 337, the integrated security devices 380, the robotic devices 390, or the controller 312. The sensors 320, the module 322, the camera 330, the thermostat 334, the module 337, the integrated security devices 380, and the robotic devices 390, can continuously transmit sensed values to the controller 312, periodically transmit sensed values to the controller 312, or transmit sensed values to the controller 312 in response to a change in a sensed value, a request, or both. In some implementations, the robotic devices 390 can communicate with the monitoring system 360 over network 305. The robotic devices 390 can connect and communicate with the monitoring system 360 using a Wi-Fi or a cellular connection or any other appropriate type of connection.

The communication links 324, 326, 328, 332, 336, 338, 384, and 386 can include any appropriate type of network, such as a local network. The sensors 320, the module 322, the camera 330, the thermostat 334, the robotic devices 390 and the integrated security devices 380, and the controller 312 can exchange data and commands over the network.

The monitoring system 360 can include one or more electronic devices, e.g., one or more computers. In some implementations, the monitoring system 360can be implemented on one of the sensors 320, e.g., such as a camera. The monitoring system 360 is configured to provide monitoring services by exchanging electronic communications with the control unit 310, the one or more devices 340 and 350, the central alarm system 370, or a combination of these, over the network 305. For example, the monitoring system 360 can be configured to monitor events (e.g., alarm events) generated by the control unit 310. In these examples, the monitoring system 360 can exchange electronic communications with the network module 314 included in the control unit 310 to receive information regarding events (e.g., alerts) detected by the control unit 310. The monitoring system 360 can receive information regarding events (e.g., alerts) from the one or more devices 340 and 350.

In some implementations, the monitoring system 360 might be configured to provide one or more services other than monitoring services. In these implementations, the monitoring system 360 might perform one or more operations described in this specification without providing any monitoring services, e.g., the monitoring system 360 might not be a monitoring system as described in the example shown in FIG. 3.

In some examples, the monitoring system 360 can route alert data received from the network module 314 or the one or more devices 340 and 350 to the central alarm system 370. For example, the monitoring system 360 can transmit the alert data to the central alarm system 370 over the network 305.

The monitoring system 360 can store sensor and image data received from the environment 300 and perform analysis of sensor and image data received from the environment 300. Based on the analysis, the monitoring system 360 can communicate with and control aspects of the control unit 310 or the one or more devices 340 and 350.

The monitoring system 360 can provide various monitoring services to the environment 300. For example, the monitoring system 360 can analyze the sensor, image, and other data to determine an activity pattern of a person of the property monitored by the environment 300. In some implementations, the monitoring system 360 can analyze the data for alarm conditions or can determine and perform actions at the property by issuing commands to one or more components of the environment 300, possibly through the control unit 310.

The central alarm system 370 is an electronic device, or multiple electronic devices, configured to provide alarm monitoring service by exchanging communications with the control unit 310, the one or more mobile devices 340 and 350, the monitoring system 360, or a combination of these, over the network 305. For example, the central alarm system 370 can be configured to monitor alerting events generated by the control unit 310. In these examples, the central alarm system 370 can exchange communications with the network module 314 included in the control unit 310 to receive information regarding alerting events detected by the control unit 310. The central alarm system 370 can receive information regarding alerting events from the one or more mobile devices 340 and 350, the monitoring system 360, or both. In some implementations, the central alarm system 370 can be implemented, at least in part if not entirely, on the monitoring system 360. In these implementations, the monitoring system 360 can perform the operations described with reference to the central alarm system 370. One or both of the monitoring system 360 or the central alarm system 370 can be implemented in the cloud.

The central alarm system 370 is connected to multiple terminals 372 and 374. The terminals 372 and 374 can be used by operators to process alerting events. For example, the central alarm system 370, e.g., as part of a first responder system, can route alerting data to the terminals 372 and 374 to enable an operator to process the alerting data. The terminals 372 and 374 can include general-purpose computers (e.g., desktop personal computers, workstations, or laptop computers) that are configured to receive alerting data from a computer in the central alarm system 370 and render a display of information using the alerting data.

For instance, the controller 312 can control the network module 314 to transmit, to the central alarm system 370, alerting data indicating that a sensor 320 detected motion from a motion sensor via the sensors 320. The central alarm system 370 can receive the alerting data and route the alerting data to the terminal 372 for processing by an operator associated with the terminal 372. The terminal 372 can render a display to the operator that includes information associated with the alerting event (e.g., the lock sensor data, the motion sensor data, the contact sensor data, etc.) and the operator can handle the alerting event based on the displayed information. In some implementations, the terminals 372 and 374 can be mobile devices or devices designed for a specific function. Although FIG. 3 illustrates two terminals for brevity, actual implementations can include more (and, perhaps, many more) terminals.

The one or more devices 340 and 350 are devices that can present content, e.g., host and display user interfaces, audio data, or both. For instance, the mobile device 340 is a mobile device that hosts or runs one or more native applications (e.g., the smart property application 342). The mobile device 340 can be a cellular phone or a non-cellular locally networked device with a display. The mobile device 340 can include a cell phone, a smart phone, a tablet PC, a personal digital assistant (“PDA”), or any other portable device configured to communicate over a network and present information. The mobile device 340 can perform functions unrelated to the monitoring system, such as placing personal telephone calls, playing music, playing video, displaying pictures, browsing the Internet, and maintaining an electronic calendar.

The mobile device 340 can include a smart property application 342. The smart property application 342 refers to a software/firmware program running on the corresponding mobile device that enables the user interface and features described throughout. The mobile device 340 can load or install the smart property application 342 using data received over a network or data received from local media. The smart property application 342 enables the mobile device 340 to receive and process image and sensor data from the monitoring system 360.

The device 350 can be a general-purpose computer (e.g., a desktop personal computer, a workstation, or a laptop computer) that is configured to communicate with the monitoring system 360, the control unit 310, or both, over the network 305. The device 350 can be configured to display a smart property user interface 352 that is generated by the device 350 or generated by the monitoring system 360. For example, the device 350 can be configured to display a user interface (e.g., a web page) generated using data provided by the monitoring system 360 that enables a user to perceive images captured by the camera 330, reports related to the monitoring system, or both. Although FIG. 3 illustrates two devices for brevity, actual implementations can include more (and, perhaps, many more) or fewer devices.

In some implementations, the one or more devices 340 and 350 communicate with and receive data from the control unit 310 using the communication link 338. For instance, the one or more devices 340 and 350 can communicate with the control unit 310 using various wireless protocols, or wired protocols such as Ethernet and USB, to connect the one or more devices 340 and 350 to the control unit 310, e.g., local security and automation equipment. The one or more devices 340 and 350 can use a local network, a wide area network, or a combination of both, to communicate with other components in the environment 300. The one or more devices 340 and 350 can connect locally to the sensors and other devices in the environment 300.

Although the one or more devices 340 and 350 are shown as communicating with the control unit 310, the one or more devices 340 and 350 can communicate directly with the sensors and other devices controlled by the control unit 310. In some implementations, the one or more devices 340 and 350 replace the control unit 310 and perform one or more of the functions of the control unit 310 for local monitoring and long range, offsite, or both, communication.

In some implementations, the one or more devices 340 and 350 receive monitoring system data captured by the control unit 310 through the network 305. The one or more devices 340 and 350 can receive the data from the control unit 310 through the network 305, the monitoring system 360 can relay data received from the control unit 310 to the one or more devices 340 and 350 through the network 305, or a combination of both. In this regard, the monitoring system 360 can facilitate communication between the one or more devices 340 and 350 and various other components in the environment 300.

In some implementations, the one or more devices 340 and 350 can be configured to switch whether the one or more devices 340 and 350 communicate with the control unit 310 directly (e.g., through communication link 338) or through the monitoring system 360 (e.g., through network 305) based on a location of the one or more devices 340 and 350. For instance, when the one or more devices 340 and 350 are located close to, e.g., within a threshold distance of, the control unit 310 and in range to communicate directly with the control unit 310, the one or more devices 340 and 350 use direct communication. When the one or more devices 340 and 350 are located far from, e.g., outside the threshold distance of, the control unit 310 and not in range to communicate directly with the control unit 310, the one or more devices 340 and 350 use communication through the monitoring system 360.

Although the one or more devices 340 and 350 are shown as being connected to the network 305, in some implementations, the one or more devices 340 and 350 are not connected to the network 305. In these implementations, the one or more devices 340 and 350 communicate directly with one or more of the monitoring system components and no network (e.g., Internet) connection or reliance on remote servers is needed.

In some implementations, the one or more devices 340 and 350 are used in conjunction with only local sensors and/or local devices in a house. In these implementations, the environment 300 includes the one or more devices 340 and 350, the sensors 320, the module 322, the camera 330, and the robotic devices 390. The one or more devices 340 and 350 receive data directly from the sensors 320, the module 322, the camera 330, the robotic devices 390, or a combination of these, and send data directly to the sensors 320, the module 322, the camera 330, the robotic devices 390, or a combination of these. The one or more devices 340 and 350 can provide the appropriate interface, processing, or both, to provide visual surveillance and reporting using data received from the various other components.

In some implementations, the environment 300 includes network 305 and the sensors 320, the module 322, the camera 330, the thermostat 334, and the robotic devices 390 are configured to communicate sensor and image data to the one or more devices 340 and 350 over network 305. In some implementations, the sensors 320, the module 322, the camera 330, the thermostat 334, and the robotic devices 390 are programmed, e.g., intelligent enough, to change the communication pathway from a direct local pathway when the one or more devices 340 and 350 are in close physical proximity to the sensors 320, the module 322, the camera 330, the thermostat 334, the robotic devices 390, or a combination of these, to a pathway over network 305 when the one or more devices 340 and 350 are farther from the sensors 320, the module 322, the camera 330, the thermostat 334, the robotic devices 390, or a combination of these.

In some examples, the monitoring system 360 leverages GPS information from the one or more devices 340 and 350 to determine whether the one or more devices 340 and 350 are close enough to the sensors 320, the module 322, the camera 330, the thermostat 334, the robotic devices 390, or a combination of these, to use the direct local pathway or whether the one or more devices 340 and 350 are far enough from the sensors 320, the module 322, the camera 330, the thermostat 334, the robotic devices 390, or a combination of these, that the pathway over network 305 is required. In some examples, the monitoring system 360 leverages status communications (e.g., pinging) between the one or more devices 340 and 350 and the sensors 320, the module 322, the camera 330, the thermostat 334, the robotic devices 390, or a combination of these, to determine whether communication using the direct local pathway is possible. If communication using the direct local pathway is possible, the one or more devices 340 and 350 communicate with the sensors 320, the module 322, the camera 330, the thermostat 334, the robotic devices 390, or a combination of these, using the direct local pathway. If communication using the direct local pathway is not possible, the one or more devices 340 and 350 communicate with the sensors 320, the module 322, the camera 330, the thermostat 334, the robotic devices 390, or a combination of these, using the pathway over network 305.

In some implementations, the environment 300 provides people with access to images captured by the camera 330 to aid in decision-making. The environment 300 can transmit the images captured by the camera 330 over a network, e.g., a wireless WAN, to the devices 340 and 350. Because transmission over a network can be relatively expensive, the environment 300 can use several techniques to reduce costs while providing access to significant levels of useful visual information (e.g., compressing data, down-sampling data, sending data only over inexpensive LAN connections, or other techniques).

In some implementations, a state of the environment 300, one or more components in the environment 300, and other events sensed by a component in the environment 300 can be used to enable/disable video/image recording devices (e.g., the camera 330). In these implementations, the camera 330 can be set to capture images on a periodic basis when the alarm system is armed in an “away” state, set not to capture images when the alarm system is armed in a “stay” state or disarmed, or a combination of both. In some examples, the camera 330 can be triggered to begin capturing images when the control unit 310 detects an event, such as an alarm event, a door-opening event for a door that leads to an area within a field of view of the camera 330, or motion in the area within the field of view of the camera 330. In some implementations, the camera 330 can capture images continuously, but the captured images can be stored or transmitted over a network when needed.

In some implementations, when a device or system transmits data to another device or system, the transmission of the data, such as a message, can cause the other device or system to perform one or more actions. For instance, transmission of a message that includes an instruction to a camera can cause the camera to capture one or more images, transmit one or more images to the device or system, or a combination of both.

Although FIG. 3 depicts the monitoring system 360 as remote from the control unit 310, in some examples the control unit 310 can be a component of the monitoring system 360. For instance, both the monitoring system 360 and the control unit 310 can be physically located at a property that includes the sensors 320 or at a location outside the property.

In some examples, some of the sensors 320, the robotic devices 390, or a combination of both, might not be directly associated with the property. For instance, a sensor or a robotic device might be located at an adjacent property or on a vehicle that passes by the property. A system at the adjacent property or for the vehicle, e.g., that is in communication with the vehicle or the robotic device, can provide data from that sensor or robotic device to the control unit 310, the monitoring system 360, or a combination of both.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user’s device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., a Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

1. A computer-implemented method comprising:
detecting, using data received from one or more sensors, a presence of a fire event in an area monitored by the one or more sensors; and
in response to detecting the presence of the fire event:
determining, using the data received from the one or more sensors and, a fire classification of the fire event;
selecting, from a plurality of automated actions for different types of fire classifications and using the fire classification of the fire event, one or more automated actions to execute; and
executing the one or more automated actions.

2. The computer-implemented method of claim 1, comprising transmitting, to a fire control system and using the presence of the fire event and the fire classification, instructions to perform a fire control action.

3. The computer-implemented method of claim 1, wherein determining the fire classification comprises:
inputting at least the data received from the one or more sensors into an artificial intelligence module; and
receiving, from the artificial intelligence module, the fire classification.

4. The computer-implemented method of claim 3, wherein the artificial intelligence module is a machine learning module trained to determine the fire classification using at least the data received from the one or more sensors.

5. The computer-implemented method of claim 3, comprising:
generating, in response to the presence of the fire event and the fire classification, a notification representing the presence of the fire event and the fire classification;
receiving, from the artificial intelligence module, a list of recipients in response to the fire classification; determining, using the data received from the one or more sensors, a recipient; and transmitting, to a device of the recipient from the list of recipients, a notification representing the presence of the fire event and the fire classification.

6. The computer-implemented method of claim 3, comprising determining, using the data received from the one or more sensors, a rate of change of the fire event.

7. The computer-implemented method of claim 6, wherein determining the rate of change of the fire event comprises receiving updated data from the one or more sensors and comparing the updated data to previously received data to determine the rate of change of the fire event.

8. The computer-implemented method of claim 7, comprising:
changing, using the rate of change of the fire event, the fire classification to generate a second fire classification;
selecting, from the plurality of automated actions, a second automated action using the second fire classification, wherein the second automated action is different than the one or more automated actions; and
executing the second automated action.

9. The computer-implemented method of claim 7, wherein determining the rate of change of the fire event comprises:
inputting the updated data into the artificial intelligence module; and
receiving, from the artificial intelligence module, the rate of change of the fire event.

10. The computer-implemented method of claim 6, wherein the rate of change is a rate of change of a region of the fire event within the area monitored by the one or more sensors, a temperature rate of change, an intensity rate of change, a rate of change of smoke concentration, or a rate of change of one or more detected chemicals.

11. The computer-implemented method of claim 1, comprising:
determining a classification of the area monitored by the one or more sensors; and
selecting, from the plurality of automated actions, the one or more automated actions using the classification of the area monitored by the one or more sensors,
generating a notification using the presence of the fire event, the fire classification, and the classification of the area monitored by the one or more sensors.

12. The computer-implemented method of claim 11, comprising determining a subclassification of the area monitored by the one or more sensors, wherein:
the subclassification is different than the classification, and the subclassification is a room type selected from a list comprising a bedroom, a living room, a kitchen, an electrical room, a basement room, or a well room; and
generating the notification uses the subclassification of the area monitored by the one or more sensors.

13. A system comprising one or more computers and one or more storage devices on
which are stored instructions that are operable, when executed by the one or more computers, to cause the one or more computers to perform operations comprising:
detecting, using data received from one or more sensors, a presence of a fire event in an area monitored by the one or more sensors; and
in response to detecting the presence of the fire event:
determining, using the data received from the one or more sensors and, a fire classification of the fire event;
selecting, from a plurality of automated actions for different types of fire classifications and using the fire classification of the fire event, one or more automated actions to execute; and
executing the one or more automated actions.

14. The system of claim 13, the operations comprising transmitting, to a fire control system and using the presence of the fire event and the fire classification, instructions to perform a fire control action.

15. The system of claim 13, wherein determining the fire classification comprises:
inputting at least the data received from the one or more sensors into an artificial intelligence module; and
receiving, from the artificial intelligence module, the fire classification.

16. The system of claim 15, wherein the artificial intelligence module is a machine learning module trained to determine the fire classification using at least the data received from the one or more sensors.

17. The system of claim 15, the operations comprising:
generating, in response to the presence of the fire event and the fire classification, a notification representing the presence of the fire event and the fire classification;
receiving, from the artificial intelligence module, a list of recipients in response to the fire classification; determining, using the data received from the one or more sensors, a recipient; and transmitting, to a device of the recipient from the list of recipients, a notification representing the presence of the fire event and the fire classification.

18. The system of claim 15, the operations comprising determining, using the data received from the one or more sensors, a rate of change of the fire event.

19. The system of claim 18, wherein determining the rate of change of the fire event comprises receiving updated data from the one or more sensors and comparing the updated data to previously received data to determine the rate of change of the fire event.

20. One or more computer storage media encoded with instructions that, when executed by one or more computers, cause the one or more computers to perform operations comprising:
detecting, using data received from one or more sensors, a presence of a fire event in an area monitored by the one or more sensors; and
in response to detecting the presence of the fire event:
determining, using the data received from the one or more sensors and, a fire classification of the fire event;
selecting, from a plurality of automated actions for different types of fire classifications and using the fire classification of the fire event, one or more automated actions to execute; and
executing the one or more automated actions.
